(19) United States
(12) Patent Application Publication
(10) Pub. No.: US 2009/0226563 A1
(43) Pub. Date: Sep. 10, 2009

(54) FAT-AND-OIL CONTAINING COMPOSITION FOR BAKERY PRODUCT

(75) Inventors: Masanobu Uchikoshi, Tokyo (JP); Shinichi Ogiwara, Tokyo (JP); Katsuyuki Kozake, Tokyo (JP); Izumi Katsuta, Tokyo (JP); Naoto Kudo, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KAO CORPORATION, Chuo-ku (JP)

(21) Appl. No.: 11/995,338

(22) PCT Filed: Jul. 12, 2006
(86) PCT No.: PCT/JP2006/314208

§ 371 Date: Aug. 8, 2008

(30) Foreign Application Priority Data
Jul. 13, 2005 (JP) 2005-204404
Jul. 13, 2005 (JP) 2005-204405
Sep. 7, 2005 (JP) 2005-258718

(51) Int. Cl. A21D 13/00; A21D 10/00

(52) U.S. Cl. 426/18; 426/558

(57) ABSTRACT

The present invention provides a fat and oil composition for bakery products, containing 20 to 60% by weight of the following components (A) and 3 to 20% by weight, on the dry-weight basis, of the following component (B):
(A) fats and oils containing 10 to 90% by weight of diacylglycerol;
(B) egg yolk and
   a bakery product containing the same.

### FIELD OF THE INVENTION

The present invention relates to a fat and oil composition used as shortening and margarine in the field of bakery.

### BACKGROUND OF THE INVENTION

Generally, bakery products based on flour represented by cake and bread have been compounded with fats and oils in the form of shortening and margarine for softening the texture and improving texture in the mouth and dissolution in the mouth, and also compounded with egg for improving not only texture in the mouth but also flavor (JP-A 64-16554).

With respect to fats and oils, techniques of improving the foaming properties of dough for bakery products without reducing the foaming properties by modifying fats and oils themselves and by developing an emulsifying agent etc. have been proposed and contributed to improvements in texture in the mouth, etc. (JP-A 5-493882). Techniques of increasing a specific volume and softening texture in the mouth, particularly by using fats and oils containing a predetermined amount of diglycerides (also called diacylglycerols) have been proposed (JP-A 2-124052, JP-A 2-124055, JP-A 4-349841). Further, there are techniques of emulsified fat and oil composition formed into a uniform flour food of good qualities with fine texture by emulsifying and dispersing diglycerides finely in an aqueous phase (JP-A 7-289143).

For cakes composed mainly of flour, eggs, fats, oils etc., a method of using pregelatinized starch (JP-A 9-224550, JP-A 9-224551), a method of using a thickening agent of polysaccharides (JP-A 2002-291396), etc. have been generally proposed as techniques of improving texture in the mouth.

Meanwhile, techniques of improving soft feel and moist feel and suppressing an odor by adding an oil-in-water emulsified fat and oil composition using diacylglycerol-containing fats and oils in an oil phase to dough have been proposed (JP-A 7-289143). The prior techniques relates to obtain a finely emulsified, stabilized emulsion and is attained by the effect of fats and oils uniformly dispersed in dough. In the case of triacylglycerol-rich fats and oils, techniques of improving soft feel and dissolving feel by adding enzymatically treated egg yolk or whole egg to dough have also been proposed. Examples of such techniques include methods which contains adding egg yolk or whole egg having a decomposition degree of 5 to 60%, or 60% or more, with phospholipase (JP-A 63-258528, JP-A 2003-325140).

### SUMMARY OF THE INVENTION

The present invention provides the following (I) to (IV): The present invention provides (I) A fat and oil composition for bakery products, containing 20 to 60% by weight of the following components (A) and 3 to 20% by weight, on the dry-weight basis, of the following component (B):
(A) fats and oils containing 10 to 90% by weight of diacylglycerol
(B) egg yolk.
   The present invention provides (II) a bakery product containing 85 to 250 parts by weight of the following component (A) and 14 to 70 parts by weight, on the dry-weight basis, of (B), relative to 100 parts by weight of flour:
   (A) fats and oils containing 10 to 90% by weight of diacylglycerol
   (B) egg yolk.
   The present invention provides (III) a bakery product which is produced by preparing the above-mentioned fat and oil composition for bakery products (D) in advance and incorporating 200 to 500 parts by weight of the component (D) into 100 parts by weight of flour.
   The present invention provides (IV) a method of producing a bakery product, including preparing the above-mentioned fat and oil composition for bakery products (D) in advance and incorporating 200 to 500 parts by weight of the component (D) into 100 parts by weight of flour.

### DETAILED DESCRIPTION OF THE INVENTION

Conventionally, there are various requirements for texture in the mouth and qualities in bakery products, and high levels are also required therefor.

The present invention relates to provide a fat and oil composition for bakery products, which can be formed into bakery products having relatively large specific volume without deflation after production and being excellent in appearance and also in texture in the mouth such as soft feeling, dissolving feel and moist feeling and superior in egg flavor, these properties being attained at extremely higher levels than conventional, and which can be used similarly to conventional shortening and margarine.

Conventionally, eggs have been incorporated for improving not only texture in the mouth but also flavor, and when eggs are incorporated in a too large amount, the flavor is improved, but there is a problem that the stability of foams in dough is lowered, the specific gravity of the dough is increased, the specific volume of bakery products is not increased, and texture in the mouth is not improved.

The present inventors made extensive study for achieving the above object, and as a result, they found that when fats and oils containing a predetermined amount of diacylglycerol are used, eggs can be incorporated in a large amount into dough, and consequently they found that the foaming properties of dough is made high, and after baking, bakery products have an increased specific gravity and are made excellent in texture in the mouth and flavor.

The fat and oil composition for bakery products of the present invention can be formed into bakery products having relatively large specific volume without deflation after production, being excellent in appearance and also in texture in the mouth such as soft feeling, dissolving feel and moist feeling and superior in egg flavor, attaining these properties at remarkably higher levels than conventional, and being usable preferably as shortening and margarine for conventional bakery products.

In the fat and oil composition for bakery of the present invention, (A) fats and oils containing 10 to 90% by weight of (hereinafter referred to simply as %) diacylglycerol are contained in an amount of 20 to 60%, more preferably 25 to 55%, even more preferably 25 to 50%, even more preferably 25 to 40%, from the viewpoint of the foaming properties of dough, prevention of deflation after baking, product appearance, excellent dissolving feel, and improvement in moist feeling. From the same viewpoint, the content of diacylglycerol in fats and oils is preferably 20 to 70%, more preferably 30 to 70%, even more preferably 35 to 70%.

In an embodiment of the present invention, the content of unsaturated fatty acids in the fatty acids constituting diacylglycerol is preferably 90% or more, more preferably 93 to 100%, even more preferably 93 to 98%, even more preferably 94 to 98%, from the viewpoint of excellent dissolution in the mouth, improvement in moist feeling, physiological effect, and industrial productivity of fats and oils. The number of carbon atoms in the unsaturated fatty acid is preferably 14 to 24, more preferably 16 to 22, from the viewpoint of the physiological effect.

In an embodiment of the present invention, the content of oleic acid in the fatty acids constituting diacylglycerol is preferably 20 to 65%, more preferably 25 to 60%, even more preferably 30 to 50%, even more preferably 30 to 45%, from the viewpoint of flavor, physiological effect and oxidation stability. From the same viewpoint, the content of olein-olein diacylglycerol is preferably less than 45%, more preferably 0 to 40%.

In an embodiment of the present invention, the content of linolic acid in the fatty acids constituting diacylglycerol is preferably 15 to 65%, more preferably 20 to 60%, even more preferably 30 to 55%, even more preferably 35 to 50%, from the viewpoint of flavor, physiological effect and oxidation stability. From the viewpoint of oxidation stability, miscibility, shape retention and physiological effect, the linolic acid/oleic acid ratio by weight is 0.01 to 2, preferably 0.1 to 1.8, more preferably 0.3 to 1.7. Particularly, the linolic acid/oleic acid ratio by weight is 2 or less in consideration of the influence on health or 0.01 or more from the viewpoint of ingestion of the essential fatty acid.

In an embodiment of the present invention, the content of linolenic acid in the fatty acids constituting diacylglycerol is preferably less than 15%, more preferably 0 to 13%, even more preferably 1 to 10%, even more preferably 2 to 9%, from the viewpoint of flavor, oxidation stability and physiological effect. As linolenic acid, α-linolenic and γ-linolenic acid are known as isomers, among which α-linolenic acid is preferable in respect of the physiological effect.

In an embodiment of the present invention, the content of saturated fatty acids in the fatty acids constituting diacylglycerol is preferably 0 to 10%, more preferably 0 to 7%, even more preferably 2 to 7%, even more preferably 2 to 6%, from the viewpoint of flavor, oxidation stability, dissolution in the mouth, physiological effect, and industrial productivity of fats and oils. The saturated fatty acid is preferably a fatty acid containing 14 to 24 carbon atoms, more preferably 16 to 22 carbon atoms, and is even more preferably palmitic acid or stearic acid.

In an embodiment of the present invention, the content of C12 or less fatty acids in the fatty acids constituting diacylglycerol is preferably 5% or less, more preferably 0 to 2%, even more preferably 0 to 1%, even more preferably substantially null, from the viewpoint of flavor. The remainder of the constituent fatty acids is preferably a fatty acid containing 14 to 24 carbon atoms, preferably 16 to 22 carbon atoms.

In an embodiment of the present invention, diacylglycerol wherein 1, 3-diacylglycerol accounts for 50% or more, preferably 52 to 100%, more preferably 54 to 90%, even more preferably 56 to 80% is preferably used from the viewpoint of the physiological effect, flavor, and industrial productivity of fats and oils.

In an embodiment of the present invention, the proportion of 1,2 (2,3)-diacylglycerol in the fat and oil composition is preferably 30% or less, more preferably 0 to 25%, even more preferably 5 to 25%, even more preferably 10 to 20%, from the viewpoint of flavor, physiological effect, and industrial productivity of fats and oils.

In an embodiment of the present invention, the diacylglycerol is produced preferably by using, as the raw material, fats and oils whose constituent fatty acids contain a large amount of unsaturated fatty acid residues, for example, vegetable fats and oils such as rapeseed oil, soybean oil, sunflower oil, safflower oil, olive oil, cottonseed oil, corn oil, palm oil, etc. or animal fats and oils such as lard, tallow, butter, etc. Specifically, these fats and oils are subjected to methods such as fractionation, mixing, ester exchange, etc. so as to have a desired fatty acid composition. Then, the fats and oils are mixed with glycerin and subjected to an ester exchange reaction in the presence of a catalyst, or more preferably the fats and oils are previously hydrolyzed in conventional methods, and the resulting fatty acids are subjected to procedures such as wintering, fractionation, distillation, etc. in conventional methods to reduce saturated fatty acids, then mixed with glycerin, and subjected to an esterification reaction in the presence of a catalyst, whereby the diacylglycerol can be obtained. Preferably, the esterification reaction is carried out under enzymatically mild conditions with 1,3-positions-selective lipase or the like, to attain excellent flavor, etc.

In an embodiment of the present invention, the content of trans-unsaturated fatty acids in the fatty acids constituting diacylglycerol is preferably 0 to 5%, more preferably 0.1 to 4.5%, even more preferably 0.2 to 4.1%, even more preferably 0.5 to 3.5%, from the view point of flavor, physiological effect, and industrial productivity of fats and oils.

In an embodiment of the present invention, the component other than diacylglycerol in fats and oils is preferably triacylglycerol. The content of triacylglycerol in fats and oils is preferably 10 to 90%, more preferably 20 to 70%, even more preferably 30 to 70%, even more preferably 35 to 70%, from the viewpoint of exhibiting foaming properties and shape retention.

In an embodiment of the present invention, the fatty acids constituting triacylglycerol contain preferably 10 to 40%, more preferably 15 to 35% and even more preferably 20 to 30% saturated fatty acids, from the view point of exhibiting foaming properties and shape retention. The saturated fatty acids are preferably those containing 14 to 24 carbon atoms, more preferably 16 to 22 carbon atoms, even more preferably palmitic acid, stearic acid, arachidonic acid and behenic acid, among which palmitic acid and stearic acid are preferable.

In an embodiment of the present invention, the content of palmitic acid (C16:0) in the fatty acids constituting triacylglycerol is preferably 1 to 45%, more preferably 3 to 35%, even more preferably 7 to 30%, from the view point of foaming properties, shape retention, plasticity, dissolution in the mouth, and flavor.

In an embodiment of the present invention, the content of stearic acid (C18:0) in the fatty acids constituting triacylglycerol is preferably 10 to 69%, more preferably 20 to 65%, even more preferably 30 to 60%, from the viewpoint of foaming properties, shape retention, plasticity, dissolution in the mouth, and flavor.

In an embodiment of the present invention, the content of arachidic acid (C20:0) in the fatty acids constituting triacylglycerol is preferably 5% or less, more preferably 0 to 3%, even more preferably 0.1 to 1%, from the viewpoint of dissolution in the mouth, shape retention and flavor.

In an embodiment of the present invention, the content of behenic acid (C22:0) in the fatty acids constituting triacylglycerol is preferably 3% or less, more preferably 0 to 2%, even more preferably 0 to 1%, from the viewpoint of dissolution in the mouth, shape retention, and flavor.

In an embodiment of the present invention, the content of unsaturated fatty acids in the fatty acids constituting triacylglycerol is preferably 25 to 55%, more preferably 27 to 50%, even more preferably 30 to 45%, even more preferably 34 to 42%, from the viewpoint of dissolution in the mouth, plasticity, and flavor.

In an embodiment of the present invention, unsaturated fatty acids constituting the triacylglycerol are preferably those containing 14 to 24 carbon atoms, more preferably 16 to 22 carbon atoms, even more preferably oleic acid, linolic acid, linolenic acid, gadoleic acid and erucic acid, among which oleic acid, linolic acid and linolenic acid are preferable.

In an embodiment of the present invention, the content of oleic acid in the fatty acids constituting triacylglycerol is preferably 5 to 30%, more preferably 10 to 20%, even more preferably 12 to 18%, from the viewpoint of shape retention, foaming properties, dissolution in the mouth, plasticity, and flavor.

In an embodiment of the present invention, the content of linolic acid in the fatty acids constituting triacylglycerol is preferably 5 to 30%, more preferably 10 to 25%, even more preferably 12 to 22%, from the viewpoint of balance among fatty acids ingested, oxidation stability, shape retention, foaming properties, dissolution in the mouth, plasticity, and flavor.

In an embodiment of the present invention, the content of linolenic acid in the fatty acids constituting triacylglycerol is preferably 0.1 to 10%, more preferably 1 to 8%, even more preferably 2 to 5%, from the viewpoint of balance among fatty acids ingested, oxidation stability, shape retention, foaming properties, dissolution in the mouth, plasticity, and flavor. Linolenic acid is preferably α-linolenic acid.

In an embodiment of the present invention, fats and oils containing a large amount of saturated fatty acids, such as palm oil, lard, tallow, etc., can be used as the raw material of triacylglycerol, or fats and oils obtained by partially hydrogenating fats and oils containing unsaturated fatty acids such as rapeseed oil and soybean oil, or a mixed oil of fully hydrogenated fats and oils and non-hydrogenated fats and oils can also be used.

Fully hydrogenated fats and oils are obtained by fully hydrogenating various vegetable oils and animal oils to an iodine value of preferably 5 or less, more preferably 0 to 2, and for example fully hydrogenated soybean oil, fully hydrogenated rapeseed oil and fully hydrogenated palm oil can be used.

The solid fat content (SFC) of the fats and oils containing to 90% diacylglycerol in an embodiment of the present invention is preferably 0 to 5 at 35° C., 1 to 15 at 25° C., 1 to 20 at 15° C., or 10 to 35 at 5° C., more preferably 0 to 3 at 35° C., 1 to 13 at 25° C., 3 to 20 at 15° C. or 13 to 35 at 5° C., even more preferably 0 to 2 at 35° C., 1 to 10 at 25° C., 5 to 20 at 15° C. or to 30 at 5° C., from the viewpoint of foaming properties, dissolution in the mouth, shape retention, texture in the mouth, etc. As used herein, the SFC (solid fat content) at 25° C. was measured in accordance with “Interim 1-1996 Solid Fat Content NMR” (Standard Analytical Methods for Fats and Oils compiled by Oil Chemists' Society, Japan). Measurement instruments include MARAN23 (Resonance Ltd.).

In the fats and oils containing 10 to 90% diacylglycerol in an embodiment of the present invention, free fatty acids or salts thereof (FFAs) are reduced to preferably 3.5% or less, more preferably 0 to 1%, even more preferably 0 to 0.5%, even more preferably 0.05 to 0.2%, from the viewpoint of flavor, emulsification properties, and industrial productivity of fats and oils.

The content of fatty acid having 4 or more carbon-carbon double bonds in all the fatty acids constituting the fats and oils containing 10 to 90% diacylglycerol in an embodiment of the present invention is preferably 0 to 40%, more preferably 0 to 20%, even more preferably 0 to 10%, even more preferably 0 to 1%, even more preferably substantially null from the viewpoint of oxidation stability, processability in production of dough, physiological effect, coloration, etc.

In the fat and oil composition for bakery of the present invention, the dry weight of (B) egg yolk is 3 to 20%, preferably 3 to 10%, more preferably 4 to 10%, even more preferably 4 to 9%, even more preferably 4 to 8%, from the viewpoint of foaming properties of dough, prevention of deflation after baking, product appearance, dissolving feel and moist feeling. Egg yolk may be incorporated in any forms of powdery or usual liquid egg yolk, or whole egg. When usual liquid egg yolk is used, the amount of liquid egg yolk used is about twice as much as the dry weight mentioned above; that is, the amount of liquid egg yolk used is preferably 6 to 42%, more preferably 6 to 21%, even more preferably 8 to 21%, even more preferably 8 to 19%, even more preferably 8 to 17%. When whole egg is used, the amount of whole egg used is about 6.4 times as much as the dry weight because whole egg contains egg white; that is, the amount of whole egg used is preferably 19 to 128%, more preferably 19 to 64%, even more preferably 25 to 64%, even more preferably 25 to 58%, even more preferably 25 to 52%. Egg yolk or whole egg may be in any frozen, salted and sweetened forms where the amount of egg yolk in terms of dry weight is in the range defined above.

Egg yolk may have been wholly or partially enzymatically treated. In this case, only egg yolk may be enzymatically treated, or whole egg may be enzymatically treated. Alternatively, only egg yolk may be enzymatically treated and then mixed with egg white. The content of the egg yolk, when expressed in terms of liquid egg yolk, is preferably 6 to 42%, more preferably 6 to 21%, even more preferably 8 to 21%, even more preferably 8 to 19%, even more preferably 8 to 17%, from the viewpoint of foaming properties of dough, prevention of deflation after baking, product appearance, excellent dissolving feel and improvement in moist feeling. When usual egg yolk that is not enzymatically treated is used, it is preferable that the upper limit in terms of liquid egg yolk is 21%, or the upper limit in terms of dry weight is 10%.

The enzyme used in enzymatically treating egg yolk is preferably esterase, lipase or phospholipase, more preferably lipase or phospholipase, particularly preferably phospholipase. In the phospholipase, phospholipase A, that is, phospholipase A1 and A2 is preferable, and particularly phospholipase A2 is preferable.

When the whole of egg yolk used is enzymatically treated egg yolk, conditions for enzyme treatment are selected such that the weight ratio of lysophospholipid to whole phospholipid in egg yolk (referred to hereinafter as “lyso ratio”) reaches 15% or more based on the amount of phosphorus. Specifically, the amount of the enzyme added is preferably 0.0001 to 0.1%, particularly preferably 0.001 to 0.01%, based on egg yolk, when the enzyme activity is 10000 IU/mL. The reaction temperature is preferably 20 to 60° C., particularly preferably 30 to 55° C. The reaction time is preferably 1 to 30 hours, particularly preferably 5 to 25 hours. When enzymatically treated egg yolk is used as apart of egg yolk, the conditions for enzyme treatment are preferably selected such that the total lyso ratio of egg yolk that is not enzymatically treated and enzymatically treated egg yolk comes to be in the range defined above. Such enzyme treatment is conducted preferably at a stage before mixing and emulsification of the raw materials.

Addition of a phytosterol component to the fat and oil composition for bakery of the present invention is preferable with respect to a blood cholesterol reduction effect, reduction of saturated fatty acids in the fatty acids constituting fats and oils containing 10 to 95% diacylglycerol, and processability into bakery products. Particularly in the present invention, a phytosterol is easily dissolved in a high conc. diacylglycerol, so even if the phytosterol is crystallized in diacylglycerol, the crystals are finer than in triacylglycerol, and thus there is an advantage of less influence on foaming properties, on dissolution in the mouth, and on feeling upon eating.

In an embodiment of the present invention, the phytosterol includes phytostanol and includes, for example, free forms of α-sitosterol, β-sitosterol, stigmasterol, 7-stigmastenol, campesterol, brassicasterol, isofucosterol, α-sitostanol, β-sitostanol, stigmastanol, 7-stigmastanol, campestanol, brassicastanol, isofucostanol, cycloartenol, cholesterol, avenasterol, etc., as well as esters thereof such as fatty acid esters, ferulic acid esters, succinic acid esters, etc.

The phytosterol fatty acid esters also include phytostanol fatty acid esters and include, example, α-sitosterol fatty acid ester, β-sitosterol fatty acid ester, stigmasterol fatty acid ester, 7-stigmastenol fatty acid ester, campesterol fatty acid ester, brassicasterol fatty acid ester, isofucosterol fatty acid ester, a-sitostanol fatty acid ester, β-sitostanol fatty acid ester, stigmastanol fatty acid ester, 7-stigmastanol fatty acid ester, campestanol fatty acid ester, brassicastanol fatty acid ester, isofucostanol fatty acid ester, cycloartenol fatty acid ester, cholesterol fatty acid ester, avenasterol fatty acid ester, etc.

In an embodiment of the present invention, brassicasterol, campesterol, stigmasterol, β-sitosterol, and fatty acid esters thereof among these phytosterols are preferable from the viewpoint of industrial productivity of fats and oils, flavor, etc. The total content of brassicasterol, campesterol, stigmasterol and β-sitosterol in the phytosterol, in terms of the phytosterol free form, is preferably 90% or more, more preferably 92 to 100%, even more preferably 94 to 99%, from the viewpoint of flavor, industrial productivity of fats and oils, crystal precipitation, and physiological effect.

In an embodiment of the present invention, the content of brassicasterol in the phytosterol, in terms of the phytosterol free form, is preferably 0.5 to 15%, more preferably 0.7 to 11%, even more preferably 3 to 10%, from the viewpoint of flavor, industrial productivity of fats and oils, crystal precipitation, and physiological effect.

In an embodiment of the present invention, the content of campesterol in the phytosterol, in terms of the phytosterol free form, is preferably 10 to 40%, more preferably 20 to 35%, even more preferably 23 to 29%, from the viewpoint of flavor, industrial productivity of fats and oils, crystal precipitation, and physiological effect.

In an embodiment of the present invention, the content of stigmasterol in the phytosterol, in terms of phytosterol free form, is preferably 3 to 30%, more preferably 11 to 25%, even more preferably 17 to 24%, from the viewpoint of flavor, industrial productivity of fats and oils, crystal precipitation, and physiological effect.

In an embodiment of the present invention, the content of β-sitosterol in the phytosterol, in terms of the phytosterol free form, is preferably 20 to 60%, more preferably 30 to 56%, even more preferably 42 to 51%, from the viewpoint of flavor, industrial productivity of fats and oils, crystal precipitation, and physiological effect.

In an embodiment of the present invention, the content of cholesterol in the phytosterol is preferably 1% or less, more preferably 0.01 to 0.8%, even more preferably 0.1 to 0.7%, even more preferably 0.2 to 0.6%, from the view point of reduction in blood cholesterol and industrial productivity of fats and oils.

In an embodiment of the present invention, the content of unsaturated fatty acids in fatty acids constituting the phytosterol fatty acid ester is preferably 80% or more, more preferably 85 to 100%, even more preferably 86 to 98%, even more preferably 88 to 93%, from the viewpoint of flavor, crystal precipitation, industrial productivity of fats and oils, oxidation stability, and physiological effect.

In an embodiment of the present invention, the content of the phytosterol based on 100 parts by weight of the fat and oil composition for bakery is preferably 0.05 to 20 parts by weight, more preferably 0.3 to 15 parts by weight, even more preferably 0.5 to 10 parts by weight, even more preferably 1 to 5 parts by weight, even more preferably 1 to 4.7 parts by weight, even more preferably 2 to 4.7 parts by weight, from the viewpoint of reduction in blood cholesterol and processability into bakery products.

The fat and oil composition for bakery of the present invention may be blended with components contained in usual fat and oil compositions, for example, antioxidants such as vitamin E (tocopherol), vitamin C or derivatives thereof (ascorbic acid palmitate, ascorbic acid stearate), butyl hydroxyl toluene (BHT), butyl hydroxyl anisole (BHA), tert-butyl hydroquinone (TBHQ), etc.

In an embodiment of the present invention, the content of the antioxidant based on 100 parts by weight of the fat and oil composition is preferably 0.005 to 0.5 part by weight, more preferably 0.04 to 0.25 part by weight, even more preferably 0.08 to 0.2 part by weight, from the viewpoint of flavor, oxidation stability, coloration, etc.

In an embodiment of the present invention, α-, β-, γ-, and δ-tocopherol or a mixture thereof can be used as vitamin E. Particularly, δ-tocopherol is preferable from the viewpoint of oxidation stability. Commercial products of vitamin E include Emix D, Emix 80 (manufactured by Eisai Co., Ltd.), MDE-6000 (manufactured by Yashiro Co., Ltd.), E-Oil-400 (manufactured by Riken Vitamin Co., Ltd.), etc. In the present invention, the content of tocopherol as vitamin E is preferably 0.01 to 0.5 part by weight, more preferably 0.02 to 0.3 part by weight, even more preferably 0.05 to 0.2 part by weight, based on 100 parts by weight of the fat and oil composition.

The content of ascorbic acid as vitamin C or its derivative in the fat and oil composition for bakery of the present invention is preferably 0.004 to 0.1 part by weight, more preferably 0.006 to 0.08 part by weight, even more preferably 0.008 to 0.06 part by weight, based on 100 parts by weight of the fat and oil composition for bakery.

When the fat and oil composition for bakery of the present invention is mixed with water or used in a water-containing food and stored for a long time or in a bright place, it is preferable for the composition to be substantially free from L-ascorbic acid fatty acid ester as the antioxidant and to use vitamin E, preferably 6-tocopherol, in order to prevent deterioration in flavor and generation of a nasty taste.

In the fat and oil composition for bakery of the present invention, a C2 to C8 organic carboxylic acid is preferably added. The content of the C2 to C8 organic carboxylic acid is preferably 0.001 to 0.01 part by weight, more preferably 0.0012 to 0.007, even more preferably 0.0015 to 0.0045 part by weight, even more preferably 0.0025 to 0.0034 part by weight, based on 100 parts by weight of the fat and oil composition, from the viewpoint of flavor, outward appearance and oxidation stability.

The fat and oil composition for bakery of the present invention may be blended if necessary with an emulsifying agent. The emulsifying agent that can be used includes lecithin, enzymatically modified lecithin, glycerin monofatty acid ester, glycerin lactic acid fatty acid ester, glycerin succinic acid fatty acid ester, glycerin acetic acid fatty acid ester, glycerin diacetyl tartaric acid fatty acid ester, sorbitan fatty acid ester, sorbitol fatty acid ester, polyoxyethylene sorbitan fatty acid ester, sucrose fatty acid ester, polyglycerin fatty acid ester, polyglycerin condensed ricinoleic acid ester, propylene glycol fatty acid ester, sodium stearoyl lactate, calcium stearoyl lactate, etc., and one or more members selected therefrom can be used.

The HLB value of the emulsifying agent is preferably 0 to 20, more preferably 1 to 16, even more preferably 7 to 15.

The content of the emulsifying agent is preferably 0.01 to 8 parts by weight, more preferably 0.02 to 5 parts by weight, even more preferably 0.05 to 2 parts by weight, even more preferably 0.07 to 1.5 parts by weight, based on 100 parts by weight of the fat and oil composition for bakery, from the viewpoint of flavor and foaming properties.

If necessary, the fat and oil composition for bakery of the present invention can make use of a coloring agent such as β-carotene or annatto extract, a flavor, a seasoning, etc.

Preferably, the fat and oil composition for bakery of the present invention further contains (C) sugars. The sugars used include monosaccharides, disaccharides, trisacchrides, tetrasacchrides, pentasaccharides and hexasaccharides such as glucose, maltose, fructose, sucrose, lactose, trehalose, maltotriose, maltotetraose, sorbitol, xylitol, erythritol, maltitol, etc., starch hydrolysates, and sugar alcohols obtained by reducing the above, mixtures thereof, and various starch syrups.

In an embodiment of the present invention, the content (% by weight) of sugars in the fat and oil composition for bakery is preferably 15 to 40%, more preferably 20 to 40%, even more preferably 25 to 40%, from the viewpoint of preservation, sweetness and toasting.

The fat and oil composition for bakery of the present invention can be used as shortening or margarine. Specifically, the fat and oil composition for bakery of the present invention can be utilized in various bakery products such as cake, steamed cake, sweet bun, waffle, scone, creampuff, Danish pastry, donut, fried food, sponge cake, butter cake, roll cake, Swiss rolls, busse, baumkuchen, pound cake, cheese cake, snack cake, etc.

The fat and oil composition for bakery of the present invention is contained preferably in an amount of 200 to 500 parts by weight in 100 parts by weight of flour to produce bakery products. Preferably, the fat and oil composition for bakery of the present invention is first incorporated into flour to prepare dough, followed by baking or steaming to produce bakery products. The content of the fat and oil composition for bakery is more preferably 200 to 450 parts by weight, even more preferably 250 to 400 parts by weight, even more preferably 300 to 400 parts by weight, from the viewpoint of easy production of bakery products, texture in the mouth, flavor etc. The composition is incorporated into flour such that the content of the component (A) in bakery products reaches preferably 85 to 250 parts by weight, more preferably 90 to 200 parts by weight, even more preferably 90 to 180 parts by weight, even more preferably 95 to 150 parts by weight, based on 100 parts by weight of flour, and also that the content of the component (B) in bakery products reaches preferably 14 to 32 parts by weight, more preferably 14 to 30 parts by weight, even more preferably 15 to 26 parts by weight, based on 100 parts by weight of flour.

In an embodiment of the present invention, the specific gravity of dough is adjusted preferably in the range of 0.5 to 0.8 g/ml before baking or steaming, from the viewpoint of a larger specific volume of bakery product and an excellent texture in the mouth, such as softness, dissolution feel in the mouth and moist feel. The specific gravity of dough is more preferably 0.53 to 0.75 g/ml, even more preferably 0.55 to 0.7 g/ml. For adjusting the specific gravity of dough in this range, it is preferable that the fat and oil composition for bakery product of the present invention is foamed so as to have a specific gravity of preferably 0.35 to 0.65 g/ml, more preferably 0.4 to 0.6 g/ml, even more preferably 0.45 to 0.6 g/ml and then mixed with flour.

In an embodiment of the present invention, the specific volume of the bakery product after baking or steaming of dough is preferably at least 3 ml/g from the viewpoint of an excellent texture in the mouth, such as softness, dissolution feel in the mouth and moist feel. The specific gravity of the product is more preferably 3 to 4 ml/g, even more preferably 3 to 3.5 ml/g.

The present invention also provides a bakery product containing 85 to 250 parts by weight of the component (A), and on a dry-weight basis, 14 to 70 parts by weight of the component (B), relative to 100 parts by weight of flour. The above detailed features of the component (A), the component (B) and other additives in the fat and oil composition for bakery product of the present invention can also apply to the bakery product. The bakery product of the present invention is described below in more detail.

The present invention relates to a bakery product having a large specific volume after production and excellent in texture in the mouth and also in egg flavor.

The present invention relates to provide bakery products having relatively large specific volume, causing no deflation, and being excellent in appearance and also in texture in the mouth such as soft feeling, dissolving feel or moist feeling and superior in egg flavor, and attaining these properties at remarkably higher levels than conventional.

The bakery products of the present invention have large specific volume, cause no deflation, are excellent in appearance, and have good texture in the mouth such as soft feeling, dissolving feel or moist feeling and an excellent egg flavor, where these properties are attained at remarkably higher levels than conventional.

In the bakery product of the present invention, (A) fats and oils containing 10 to 90% diacylglycerol are contained preferably in an amount of 85 to 250 parts by weight, more preferably 90 to 200 parts by weight, even more preferably 90 to 180 parts by weight, even more preferably 95 to 150 parts by weight, based on 100 parts by weight of flour, from the viewpoint of foaming properties of dough, prevention of deflation after baking, product appearance, excellent dissolving feel and moist feeling. From the same viewpoint, the content of diacylglycerol in fats and oils is preferably 20 to 70%, more preferably 30 to 70%, even more preferably 35 to 70%.

In the bakery product of the present invention, the dry weight of (B) egg yolk is preferably 14 to 70 parts by weight, more preferably 14 to 32 parts by weight, even more preferably 14 to 30 parts by weight, even more preferably 15 to 26 parts by weight, even more preferably 15 to 24 parts by weight, based on 100 parts by weight of flour, from the viewpoint of foaming properties of dough, prevention of deflation after baking, product appearance, dissolving feel and moist feeling. When the bakery product of the present invention is produced, egg yolk may be incorporated in any forms of powdery or usual liquid egg yolk, or whole egg. When usual liquid egg yolk is used, the amount of liquid egg yolk used is about twice as much as the dry weight mentioned above; that is, the amount of liquid egg yolk used is preferably 28 to 140 parts by weight, more preferably 28 to 64 parts by weight, even more preferably 28 to 60 parts by weight, even more preferably 30 to 52 parts by weight, even more preferably 30 to 48 parts by weight, based on 100 parts by weight of flour. When whole egg is used, the amount of the whole egg used is about 6.4 times as much as the dry weight because the whole egg contains egg white; that is, the amount of whole egg used is preferably 90 to 448 parts by weight, more preferably 90 to 205 parts by weight, even more preferably 90 to 192 parts by weight, even more preferably 96 to 166 parts by weight, even more preferably 96 to 154 parts by weight. Egg yolk or whole egg may be in any frozen, salted and sweetened forms.

Egg yolk may have been wholly or partially enzymatically treated. In this case, only egg yolk may be enzymatically treated, or whole egg may be enzymatically treated. Alternatively, only egg yolk may be enzymatically treated and then mixed with egg white. The dry weight of the egg yolk is preferably 14 to 70 parts by weight, more preferably 14 to 32 parts by weight, even more preferably 14 to 30 parts by weight, even more preferably 15 to 24 parts by weight, based on 100 parts by weight of flour, from the viewpoint of foaming properties of dough, prevention of deflation after baking, product appearance, excellent dissolving feel and improvement in moist feeling. The amount of the egg yolk, when expressed in terms of liquid egg yolk, is about twice as much as the dry weight mentioned above; that is, the amount is preferably 28 to 140 parts by weight, more preferably 28 to 64 parts by weight, even more preferably 28 to 60 parts by weight, even more preferably 30 to 52 parts by weight, even more preferably 30 to 48 parts by weight, based on 100 parts by weight of flour. When usual egg yolk that is not enzymatically treated is used, it is preferable that the upper limit in terms of dry weight is 32 parts by weight, or the upper limit in terms of liquid egg yolk is 64 parts by weight, based on 100 parts by weight of flour.

In an embodiment of the present invention, the content of phytosterol is preferably 0.045 to 40 parts by weight, more preferably 0.3 to 30 parts by weight, even more preferably 0.45 to 20 parts by weight, even more preferably 0.9 to 10 parts by weight, even more preferably 0.9 to 9.4 parts by weight, even more preferably 1.8 to 9.4 parts by weight, based on 100 parts by weight of flour, from the viewpoint of cholesterol lowering effects and processability into bakery products.

In an embodiment of the present invention, the content of the antioxidant is preferably 0.0045 to 1 part by weight, more preferably 0.036 to 0.5 part by weight, even more preferably 0.072 to 0.4 part by weight, based on 100 parts by weight of flour, from the viewpoint of flavor, oxidation stability, coloration, etc.

In an embodiment of the present invention, α-, β-, γ- and δ-tocopherol or a mixture thereof can be used as vitamin E. Particularly, δ-tocopherol is preferable from the viewpoint of oxidation stability. Commercial products of vitamin E include Emix D, Emix 80 (manufactured by Eisai Co., Ltd.), MDE-6000 (manufactured by Yashiro Co., Ltd.), E-Oil-400 (manufactured by Riken Vitamin Co., Ltd.), etc. In the present invention, the content of tocopherol as vitamin E is preferably 0.009 to 1 part by weight, more preferably 0.018 to 0.6 part by weight, even more preferably 0.02 to 0.4 part by weight, based on 100 parts by weight of flour.

The content of vitamin C or its derivative in the bakery product of the present invention is preferably 0.0036 to 0.2 part by weight, more preferably 0.0054 to 0.16 part by weight, even more preferably 0.0072 to 0.12 part by weight, based on 100 parts by weight of flour, as ascorbic acid.

When the bakery product of the present invention is mixed with water or used in a water-containing food and stored for a long time or in a bright place, it is preferable for the bakery product to be substantially free from L-ascorbic acid fatty acid ester as the antioxidant and to use vitamin E, preferably 6-tocopherol, in order to prevent deterioration in flavor and generation of a nasty taste.

In the bakery product of the present invention, a C2 to C8 organic carboxylic acid is preferably contained. The content of the C2 to C8 organic carboxylic acid is preferably 0.0009 to 0.02 part by weight, more preferably 0.0018 to 0.14 part by weight, even more preferably 0.00135 to 0.009 part by weight, even more preferably 0.00225 to 0.0068 part by weight, based on 100 parts by weight of flour, from the viewpoint of flavor, outward appearance and oxidation stability.

The bakery product of the present invention may be blended if necessary with an emulsifying agent. The emulsifying agent that can be used includes lecithin, enzymatically modified lecithin, glycerin monofatty acid ester, glycerin lactic acid fatty acid ester, glycerin succinic acid fatty acid ester, glycerin acetic acid fatty acid ester, glycerin diacetyl tartaric acid fatty acid ester, sorbitan fatty acid ester, sorbitol fatty acid ester, polyoxyethylene sorbitan fatty acid ester, sucrose fatty acid ester, polyglycerin fatty acid ester, polyglycerin condensed ricinoleic acid ester, propylene glycol fatty acid ester, sodium stearoyl lactate, calcium stearoyl lactate, etc., and one or more members selected therefrom can be used.

The content of the emulsifying agent is preferably 0.009 to 16 parts by weight, more preferably 0.018 to 10 parts by weight, even more preferably 0.045 to 4 parts by weight, even more preferably 0.063 to 3 parts by weight, based on 100 parts by weight of flour, from the viewpoint of flavor, foaming properties etc.

Preferably, the bakery product of the present invention further contains sugars (C). The sugars used include monosaccharides, disaccharides, trisacchrides, tetrasacchrides, pentasaccharides and hexasaccharides such as glucose, maltose, fructose, sucrose, lactose, trehalose, maltotriose, maltotetraose, sorbitol, xylitol, erythritol, maltitol, etc., starch hydrolysates, and sugar alcohols obtained by reducing the above, mixtures thereof, and various starch syrups.

In an embodiment of the present invention, the content of sugars is preferably 90 to 150 parts by weight, more preferably 90 to 140 parts by weight, even more preferably 90 to 130 parts by weight, based on 100 parts by weight of flour, from the viewpoint of preservation, sweetness and toasting.

Specific examples of the bakery product of the present invention include various bakery products such as cake, steamed cake, sweet bun, waffle, scone, creampuff, Danish pastry, donut, fried food, sponge cake, butter cake, roll cake, Swiss rolls, busse, baumkuchen, pound cake, cheese cake, snack cake, etc.

From the viewpoint of easy production of bakery products, texture in the mouth, flavor etc. it is preferable that the bakery products of the present invention are produced by previously preparing a component (D), that is, a fat and oil composition for bakery products, containing 20 to 60% by weight of (A) fats and oils containing 10 to 90% by weight of diacylglycerol and 3 to 20% by weight, on a dry-weight basis, of (B) egg yolk, and then incorporating 200 to 500 parts by weight of the component (D) into 100 parts by weight of flour. The content of the component (D) is more preferably 200 to 450 parts by weight, even more preferably 250 to 400 parts by weight, even more preferably 300 to 400 parts by weight, based on 100 parts by weight of flour. In this case, it is preferable that the component (D) has previously contained the phytosterols, antioxidants, organic carboxylic acids, emulsifying agent, sugars etc. described above.

The method of preparing dough to be formed into the bakery products of the present invention may be (1) a method of mixing the component (D) with flour, (2) a method of mixing the components (A) and (B) and other components with one another, then whipping the mixture and mixing it with flour (sugar batter method), or (3) a method of mixing the components (A) and (B), other components and flour with one another (all-in-mix method), among which the method (1) is preferable from the viewpoint of easy production of bakery products, texture in the mouth, flavor etc. The bakery products of the present invention are produced by baking or steaming dough prepared by any of the methods (1) to (3) described above.

In an embodiment of the present invention, the specific gravity of dough before baking or steaming is adjusted preferably in the range of 0.5 to 0.8 g/ml, from the viewpoint of a larger specific volume of the products and improvements in texture in the mouth such as soft feeling, dissolving feel and moist feeling. The specific gravity of dough is more preferably 0.53 to 0.75 g/ml, even more preferably 0.55 to 0.7 g/ml. For adjusting the specific gravity of dough in the range defined above, it is preferable that the component (D) is whipped in the case of the dough preparation method (1), or the components (A) and (B) and other components are mixed and then whipped in the case of the dough preparation method (2), and then the specific gravity thereof is adjusted in the range of preferably 0.35 to 0.65 g/ml, more preferably 0.4 to 0.6 g/ml, even more preferably 0.45 to 0.6 g/ml, followed by mixing the product with flour.

The bakery products of the present invention include cakes such as cake, steamed cake and sponge cake, and when diacylglycerol-containing fats and oils are used in the cakes, the use of enzymatically treated egg yolk or whole egg (hereinafter referred to simply as “enzymatically treated egg yolk etc.”) is preferable from the viewpoint of the texture in the mouth such as soft feeling, dissolving feel, etc. and larger volume of the cakes. Now, the method of producing cakes using enzymatically treated egg yolk etc., a fat and oil composition for cakes using enzymatically treated egg yolk etc., and cakes using the fat and oil composition is described in detail.

The cakes have attained reasonable effects on improvements in texture in the mouth such as soft feeling and dissolving feel, but when diacylglycerols (DAGs) are used, a long time may be required for attaining a predetermined specific gravity of dough, while when triacylglycerols (TAGs) are used, there is a disadvantage of insufficient volume, so either DAG or TAG cannot be said to be satisfactory in achieving both excellent appearance and workability required of cakes.

In the present invention, when cakes use diacylglycerols in an amount above a certain level, the cakes are preferably those containing enzymatically treated egg yolk etc. to improve texture in the mouth such as soft feeling and dissolving feel, to increase the volume of the cakes and to improve the outward appearance thereof.

When enzymatically treated egg yolk etc. are used in cakes, diacylglycerols are contained in an amount of preferably 20 parts by weight or more, more preferably 30 to 60 parts by weight, even more preferably 40 to 55 parts by weight or more, based on 100 parts by weight of flour, from the view point of the emulsion stability of dough, excellent texture in the mouth such as soft feeling and dissolving feel, increased cake volume, and workability. Triacyglycerols, monoacylglycerols, free fatty acids etc. may be partially contained in addition to diacylglycerols. Preferably, the diacylglycerols are incorporated as diacylglycerol-rich fat and oil, from the viewpoint the emulsion stability of dough, excellent texture in the mouth such as soft feeling and dissolving feel, increased cake volume, and workability. As diacylglycerols, the above-mentioned fats and oils (A) containing 10 to 90% by weight of diacylglycerol are preferably used, and in this case, (A) may be incorporated in an amount of 20 parts by weight or more based on 100 parts by weight of flour. That is, (A) is incorporated in an amount of 22.2 parts by weight or more based on 100 parts by weight of flour.

The enzymatically treated egg yolk etc. are those prepared by enzymatically treating egg yolk in raw eggs or in any arbitrary forms such as frozen, powdered, salted or sweetened forms. The enzymatically treated egg yolk etc. may be in the form of egg white-containing whole egg. The content of the enzymatically treated egg yolk, when expressed in terms of liquid egg yolk, is preferably 80 to 140 parts by weight, more preferably 90 to 130 parts by weight, even more preferably 100 to 120 parts by weight, based on 100 parts by weight, from the viewpoint of emulsion stability, soft feeling and excellent dissolving feel, cake volume, and improvement in flavor. Because about half of the liquid egg yolk is water, the dry weight of liquid egg yolk is preferably 40 to 70 parts by weight, more preferably 45 to 65 parts by weight, even more preferably 50 to 60 parts by weight, based on 100 parts by weight of flour.

The degree of decomposition of phospholipids by enzyme treatment is not particularly limited, but the lyso ratio of the enzymatically treated egg yellow is preferably 15% or more, more preferably 50% or more, even more preferably 60 to 100%, even more preferably 80 to 95%, based on the amount of phosphorus, from the viewpoint of emulsion stability, soft feeling and excellent dissolving feel, and increased cake volume. The phospholipids are preferably those derived from egg yolk as described above, but those derived from soybean can also be used, and those derived from egg yolk can be used in combination with those derived from soybean.

When the whole of egg yolk is used as enzymatically treated egg yolk, conditions for enzyme treatment are selected such that the lyso ratio reaches 15% or more. Specifically, the amount of the enzyme added is preferably 0.001 to 0.1% by weight, particularly preferably 0.001 to 0.01% by weight, based on egg yolk, when the enzyme activity is 10000 IU/mL. The reaction temperature is preferably 20 to 60° C., particularly preferably 30 to 55° C. The reaction time is preferably 1 to 30 hours, particularly preferably 5 to 25 hours. When enzymatically treated egg yolk is used as a part of egg yolk, the conditions for enzyme treatment are preferably selected such that the total lyso ratio of egg yolk not enzymatically treated and enzymatically treated egg yolk comes to be in the range defined above. Such enzyme treatment is conducted preferably at a stage before emulsification of a mixture of the respective raw materials.

In an embodiment of the present invention, cakes are produced preferably by previously preparing (E) a fat and oil composition for cakes containing diacylglycerols, enzymatically treated egg yolk etc., and then using (E) to form cakes, from the viewpoint of emulsion stability and industrial productivity.

The content of diacylglycerols in the fat and oil composition for cakes (E) is preferably 10% or more, more preferably 20 to 50%, even more preferably 25 to 45%, from the viewpoint of emulsion stability, soft feeling and excellent dissolving feel, increased cake volume, and workability. The diacylglycerol are incorporated preferably as diacylglycerol-rich fat and oil, from the viewpoint of industrial productivity. The fats and oils may partially contain triacylglycerol, monoacylglycerol, free fatty acid, etc. in addition to the diacylglycerol. The diacylglycerol used are preferably the above-mentioned fats and oils (A) containing 10 to 90% diacylglycerol, and in this case, (A) may be incorporated in an amount of 100 or more in the fat and oil composition for cakes (E). That is, (A) is incorporated preferably in an amount of 11.1% or more in the fat and oil composition for cakes (E). The fat and oil composition is defined by diacylglycerol-rich fat and oil and egg yolk of enzymatically treated egg yolk.

The content, in terms of dry weight, of enzymatically treated egg yolk etc. in the fat and oil composition for cakes (E) is preferably 10% or more, more preferably 10 to 30%, even more preferably 15 to 25%, from the viewpoint of the emulsion stability of dough, soft feeling and excellent dissolving feel, increased cake volume, and workability.

In an embodiment of the present invention, the fat and oil composition for cakes (E), when incorporated for producing cakes, is incorporated in an amount of preferably 120 to 200 parts by weight, more preferably 130 to 190 parts by weight, even more preferably 150 to 180 parts by weight, based on 100 parts by weight of flour, from the viewpoint of emulsion stability, soft feeling and excellent dissolving feel, and increased cake volume. The process for producing the cakes includes a general all-in-mix method, a cold sponge method, a hot sponge method, etc.

In the present invention, the cakes include sponge cake, butter cake, chiffon cake, roll cake, Swiss roll, busse, baumkuchen, pound cake, cheese cake, snack cake, steamed cake, etc. The present invention can also be applied to steamed buns obtained by subjecting dough to heating such as baking, donuts, hot cakes, bean-jam pancakes, and Japanese muffins, any of which fall under the scope of the cakes in the present invention.

The fat and oil composition for cakes (E), when used to produce cakes, may be compounded with other ingredients conventionally used in cakes, such as a humectant, an emulsifier, sugars, starches, amino acids, proteins, common salt, a preservative, a pH adjusting agent, a colorant, a spice, etc. These ingredients may be previously incorporated into the fat and oil composition for cakes of the present invention.

The humectant includes a protein and a thickening polysaccharide. The protein may be any protein that exhibits viscosity upon dissolution in water, and includes milk protein, vegetable protein, etc. The humectant incorporated is preferably 0.001 to 2 parts by weight, more preferably 0.05 to 1.0 part by weight, even more preferably 0.15 to 0.8 part by weight, even more preferably 0.20 to 0.5 part by weight, from the viewpoint of exhibiting a staleness-preventing effect and soft feeling and excellent dissolving feel.

The milk protein includes sodium casein, calcium casein, rennet casein, milk casein, milk whey, lactalbumin, lactoglobulin, etc. The vegetable protein includes soybean protein, wheat protein, etc. The thickening polysaccharides include gellan gum, karaya gum, tamarind seed gum, cod gum, glucomannan, xanthane gum, locust bean gum, pullulan, guar gum, iotacarrageenan, HM pectin, LM pectin, tragacanth gum, crystalline cellulose, PGA (propylene glycol alginate), SSHC (water-soluble soybean polysaccharide), gum ghatti, methyl cellulose, psyllium seed and cassia gum.

The emulsifying agent includes glycerin fatty esters, sucrose fatty esters, sorbitan fatty esters, propylene glycol fatty esters, lecithin, lecithin derivatives and polysorbates. The amount of the emulsifying agent incorporated is preferably 0.33 to 12.8 parts by weight, more preferably 1 to 10 parts by weight, even more preferably 2 to 8 parts by weight, based on 100 parts by weight of flour, from the viewpoint of attaining emulsion stability, a sufficient effect of preventing aging, and texture in the mouth with softness and a good dissolution in the mouth.

The sugars include sugar, starch syrup, maltose, glucose, isomerized sugar, lactose, oligosaccharide, fructose and sorbit and are incorporated preferably in an amount of 80 to 300 parts by weight based on 100 parts by weight of flour. If necessary, baking powder, water etc. may be incorporated.

### EXAMPLES

Hereinafter, the Examples are described, but the scope of the invention is not limited to the following examples. [Preparation of Fat and Oil 1 (Diacylglycerol-Rich Fat and Oil)]

455 parts by weight of soybean oil fatty acids wherein saturated fatty acid had been reduced by wintering, 195 parts by weight of rapeseed oil fatty acids, and 107 parts by weight of glycerin, were esterified by ripozyme IM (manufactured by Novozymes Co., Ltd.) at 0.07 hPa at 40° C. for 5 hours. Then, the enzyme was separated by filtration, and the reaction mixture was subjected to molecular distillation at 235° C., then decolorized and washed with water. Then, 7.5 parts by weight of 10% aqueous citric acid were added to 150 parts by weight of the resulting fat and oil which were then stirred at 60° C. for 20 minutes and then dehydrated at 110° C. The product was deodorized at 235° C. for 2 hours to prepare the fat and oil 1.

### [Preparation of Fat and Oil 2 (Vegetable Hydrogenated Fat and Oil)]

Fat and oil having a melting point of 38° C., based on hydrogenated palm oil and hydrogenated rapeseed oil, was prepared in the following method. A nickel catalyst (N122AF3, Nikki Chemical Co., Ltd.) was added in an amount of 0.06% to palm oil and rapeseed oil which were then hydrogenated at 170° C. at 3.5 to 4.0 kg/cm² until their melting point reached 38° C. After hydrogenation, the product was deodorized in a usual manner (230° C., 2 hours, with 3% water vapor), thereby purifying the fat and oil.

The fat and oil 1 and 2 were analyzed by the following method. The results are shown in Table 1.

TABLE 1

| | Fat | Fat | Fat |
|---|---|---|---|
| | and oil | and oil | and oil |
| | 1 | 2 | 3 |
| Glyceride composition (wt %) | | | |
| TAG | 13.2 | 96.4 | 98.2 |
| DAG | 85.9 | 2.9 | 1.0 |
| [1,3DAG] | [59.3] | [1.8] | [0.6] |
| MAG | 0.8 | 0.6 | 0.7 |
| FFA | 0.1 | 0.1 | 0.1 |
| Constituent fatty acid | | | |
| composition (wt %) | | | |
| C16:0 | 3.1 | 23.9 | 3.6 |
| C18:0 | 1.3 | 7.1 | 1.7 |
| C18:1 | 38.0 | 63.5 | 57.1 |
| C18:2 | 47.9 | 1.1 | 21.9 |
| C18:3 | 8.3 | 1.4 | 12.7 |
| Others | 1.4 | 3.0 | 3.0 |

TAG: Triacylglycerol DAG: Diacylglycerol MAG: Monoacylglycerol FFA: Free fatty acid

### [Analysis Methods]

### (i) Glyceride Composition

A 10 mg sample and 0.5 mL trimethylsilylating agent (“Silylating agent TH”, manufactured by Kanto Chemical Co., Inc.) were added to a sample bottle made of glass, sealed and heated at 70° C. for 15 minutes. The product was subjected to gas chromatography (GLC) to analyze its glyceride composition.

### GLC Conditions

Unit: 6890 model manufactured by Hewlett Packard
Column: DB-1HT (manufactured by J&W Scientific) 7 m
Column temperature: initial=80° C., final=340° C.
Increasing temperature=10° C./min., kept at 340° C. for 20 minutes
Detector: FID, temperature=350° C.
Injection part: split ratio=50:1, temperature=320° C.
Sample injection volume: 1 μL
Carrier gas: helium, flow rate=1.0 mL/min.

### (ii) Constituent Fatty Acid Composition

Fatty acid methyl ester was prepared according to “Method of Preparing Fatty Acid Methyl Ester (2.4.1.2-1996)” in “Standard Fat and Oil Analysis Test Method” edited by Japan Oil Chemists' Society. The resulting sample was subjected to GLC and analyzed for its constituent fatty acid composition (American Oil Chem. Soc. Official Method: Celf-96, 2002).

### [Preparation of Fat and Oil Composition for Bakery Products]

The fat and oil 1, the fat and oil 2, and fat and oil 3 (that is, rapeseed oil) were used in the compositions shown in Table 2, to prepare various fat and oil compositions for bakery products (Compositions A to G). The components in Table 2 were mixed, dissolved at 60° C., cooled to 15° C. at a cooling rate of −5° C./min. with a chiller (emulsifying kneader, Tama Seiki Kogyo Co., Ltd.), then tempered at 20° C. for 1 day and stored in a refrigerator (5° C.), to prepare the fat and oil compositions for bakery products. Separately, the solid fat content (SFC) of the fat and oil composition of only fat and oil was measured with MARAN23 (Resonance Ltd.). Whole egg was incorporated assuming that its weight was 6.4-times as much as the dry weight of egg yolk.

TABLE 2

| | | Composition | Composition | Composition | Composition | Composition | Composition | Composition |
|---|---|---|---|---|---|---|---|---|
| Blending | | A | B | C | D | E | F | G |
| Fat and oil 1 (parts by | | 50 | 50 | 50 | 70 | — | 22.5 | 77.5 |
| weight) | | | | | | | | |
| Fat and oil 2 (parts by | | 50 | 50 | 50 | 30 | 50 | 22.5 | 77.5 |
| weight) | | | | | | | | |
| Fat and oil 3 (parts by | | — | — | — | — | 50 | — | — |
| weight) | | | | | | | | |
| Whole egg (parts by | | 100 (15.6) | 120 (18.8) | 150 (23.4) | 150 (23.4) | 100 (15.6) | 155 (24.2) | 45 (7) |
| weight) (dry weight) | | | | | | | | |
| White superior soft | | 100 | 100 | 100 | 100 | 100 | 100 | 100 |
| sugar (parts by weight) | | | | | | | | |
| Content of DAG in Fat | | 42.5 | 42.5 | 42.5 | 59.5 | 2.4 | 42.5 | 42.5 |
| and oil (wt %) | | | | | | | | |
| Amount of fat and oil in | | 33.3 | 31.3 | 28.6 | 28.6 | 33.3 | 15.0 | 51.7 |
| the composition (wt %) | | | | | | | | |
| Dry egg yolk in the | | 5.2 | 5.9 | 6.7 | 6.7 | 5.2 | 8.1 | 2.3 |
| composition (wt %) | | | | | | | | |
| SFC of | 5° C. | 25.2 | 25.2 | 25.2 | 16.3 | 26.1 | 25.2 | 25.2 |
| fat and | 10° C. | 20.6 | 20.6 | 20.6 | 12.3 | 18.2 | 20.6 | 20.6 |
| oil | 15° C. | 15.1 | 15.1 | 15.1 | 7.9 | 16.3 | 15.1 | 15.1 |
| | 20° C. | 10.9 | 10.9 | 10.9 | 5.3 | 11.4 | 10.9 | 10.9 |
| | 25° C. | 8.0 | 8.0 | 8.0 | 2.7 | 7.0 | 8.0 | 8.0 |
| | 30° C. | 3.7 | 3.7 | 3.7 | 0.9 | 3.5 | 3.7 | 3.7 |
| | 35° C. | 0.6 | 0.6 | 0.6 | 0.0 | 0.3 | 0.6 | 0.6 |

### Test Examples 1 to 12

By the formulation shown in Table 3, cake dough was prepared, and the dough was baked or steamed. To prepare dough in each of Test Examples 1 to 6, 11 and 12, one of the compositions A to G in Table 2 was whipped with a mechanical mixer to give a whipped product having a specific gravity of 0.5 g/ml, and then weak flour and baking powder were added to and mixed with it thereby preparing the dough. Dough in Test Example 7 was prepared by the dough preparation method 1, and dough in each of Test Examples 8 to 10 was prepared by the dough preparation method 2.220 g of the resulting dough was introduced into a round metal frame No. 4 (diameter 12 cm, height 5.5 cm) and baked for 35 minutes in an electric oven set at 175 to 180° C. The resulting bakery product was left at room temperature (20 to 25° C.) for 1 day and then evaluated. Separately, 45 g of the same dough was introduced into a glassine cup (diameter 5.5 cm, height 3.5 cm) and steamed at 91° C. for 18 minutes. The resulting bakery product was left at room temperature (20 to 25° C.) for 1 day and then evaluated. The specific gravity of the cake dough, and the specific volume, deflation, surface condition, and texture in the mouth (dissolving feel, moist feeling, disassembling feeling, and egg taste) of the cake obtained by baking or steaming the cake dough were evaluated by the following respective evaluation methods and evaluation criteria. The results are shown in Table 3.

### [Dough Preparation Method 1 (Sugar Batter Method)]

Fats and oils and white superior soft sugar were mixed, whipped and further whipped while whole eggs at room temperature were gradually added thereto. Thereafter, weak flour and baking powder were added to and mixed with it to give dough which was then measured for its specific gravity.

[Dough Preparation Method 2 (all-in-Mix Method)]

White superior soft sugar and whole eggs were added to, and mixed with, weak flour to prepare dough, and the specific gravity of the dough was measured.

TABLE 3

| Blended with cake dough | Test example | | | | | | | | | | | |
|---|---|---|---|---|---|---|---|---|---|---|---|---|
| (parts by weight) | 1 | 2 | 3 | 4 | 5 | 6 | 7 | 8 | 9 | 10 | 11 | 12 |
| Composition A | 300 | | | | 400 | | | | | | | |
| Composition B | | 320 | | | | | | | | | | |
| Composition C | | | 350 | | | | | | | | | |
| Composition D | | | | 350 | | | | | | | | |
| Composition E | | | | | | 300 | | | | | | |
| Composition F | | | | | | | | | | | 300 | |
| Composition G | | | | | | | | | | | | 300 |
| Fat and oil 1 | (50) | (50) | (50) | (70) | (75) | | 75 | 75 | 20 | 60 | (22.5) | (77.5) |
| Fat and oil 2 | (50) | (50) | (50) | (30) | (75) | (50) | 75 | 75 | 60 | 20 | (22.5) | (77.5) |
| Fat and oil 3 | | | | | | (50) | | | | | | |
| Whole egg | (100) | (120) | (150) | (150) | (150) | (100) | 150 | 150 | 90 | 90 | (155) | (45) |
| (dry weight) | (15.6) | (18.8) | (23.4) | (23.4) | (23.4) | (15.6) | (23.4) | (23.4) | (14.1) | (14.1) | (24.2) | (7) |
| White superior soft | (100) | (100) | (100) | (100) | (100) | (100) | 100 | 100 | 80 | 80 | (100) | (100) |
| sugar | | | | | | | | | | | | |
| Weak flour *¹⁾ | 100 | 100 | 100 | 100 | 100 | 100 | 100 | 100 | 100 | 100 | 100 | 100 |
| Baking powder *²⁾ | 2 | 2 | 2 | 2 | 2 | 2 | 2 | 2 | 2 | 2 | 2 | 2 |
| Evaluation results | | | | | | | | | | | | |
| Specific gravity of | 0.68 | 0.65 | 0.61 | 0.56 | 0.58 | 0.82 | 0.56 | 0.60 | 0.80 | 0.78 | 0.91 | 0.65 |
| dough after production | | | | | | | | | | | | |
| (g/ml) | | | | | | | | | | | | |
| After baking | | | | | | | | | | | | |
| Cake specific volume | 3.12 | 3.32 | 3.51 | 3.64 | 3.53 | 1.89 | 3.58 | 3.41 | 2.07 | 2.11 | 1.88 | 2.16 |
| (ml/g) | | | | | | | | | | | | |
| Deflation | 3 | 3 | 3 | 3 | 3 | 1 | 3 | 3 | 2 | 2 | 1 | 3 |
| Dissolving feel | 3 | 3 | 3 | 3 | 4 | 1 | 4 | 4 | 2 | 3 | 1 | 1 |
| Moist feel | 3 | 3 | 3 | 4 | 4 | 1 | 4 | 4 | 1 | 1 | 1 | 2 |
| Egg taste | 3 | 3 | 4 | 4 | 4 | 1 | 4 | 4 | 2 | 2 | 3 | 1 |
| After steaming | | | | | | | | | | | | |
| Cake specific volume | 3.01 | 3.12 | 3.22 | 3.05 | 3.03 | 1.72 | 3.07 | 3.00 | 1.81 | 1.83 | 1.64 | 1.96 |
| (ml/g) | | | | | | | | | | | | |
| Surface appearance | 3 | 3 | 3 | 3 | 3 | 1 | 3 | 3 | 2 | 2 | 1 | 2 |
| Dissolving feel | 3 | 3 | 3 | 3 | 4 | 1 | 4 | 4 | 2 | 2 | 1 | 1 |
| Disassembling feeling | 3 | 4 | 4 | 4 | 4 | 1 | 4 | 4 | 1 | 1 | 1 | 1 |
| Egg taste | 3 | 3 | 4 | 4 | 4 | 1 | 4 | 4 | 2 | 2 | 1 | 1 |

Numerical value in parentheses refers to the amount of ingredient in each of Compositions A to G
^{*1)} “Biolet”, The Nisshin Flour Milling Co., Ltd.
^{*3)} “Aikoku Baking Powder”, Ohmiya Shokuryo Kogyo
[Measurement of dough specific gravity]
The specific gravity of the resulting dough was measured with a specific gravity cup.
Specific Gravity (g/ml) = Weight (g) of Dough/Content (ml) of Specific Gravity Cup
[Measurement of cake specific volume]
The specific volume of the cake was measured with a laser volume measuring instrument (Selnac-VM ASTEX).
[Evaluation criteria for deflation]
4: Sufficiently inflated after baking.
3: Inflated after baking.
2: Slightly inflated after baking.
1: Not inflated after baking.
[Evaluation criteria for surface condition]
4: Very smooth on the surface.
3: Smooth on the surface.
2: Slightly roughened on the surface.
1: Significantly roughened on the surface.
[Evaluation criteria for dissolving feel]
4: Feels rapidly dissolved in the mouth upon mastication.
3: Feels dissolved in the mouth upon mastication.
2: Feels slightly sticky.
1: Feels sticky.
[Evaluation criteria for moist feeling]
4: Very moist texture in the mouth.
3: Moist texture in the mouth.
2: Feels slightly dry.
1: Feels dry.
[Evaluation criteria for disintegrating feeling]
4: Rapidly disintegrated in the mouth.
3: Disintegrated in the mouth.
2: Agglomerates remain in the mouth.
1: Agglomerates remain and do not dissolve in the mouth.
[Evaluation criteria for egg taste]
4: Very rich egg taste.
3: Rich egg taste.
2: Slight egg taste.
1: No or less egg taste.

In the Test Examples using Compositions A to D as the products of the present invention, the foaming properties of cake dough was excellent, and the specific volume of each cake after baking or steaming was large, as compared with the other test examples. There was rarely deflation during baking, and the surface condition after steaming was excellent. Further, the product was excellent in dissolving feel, moist feeling, disassembling feeling in the mouth, and egg taste.

Hereinafter, the present invention is described in more detail by reference to examples of cakes using enzymatically treated egg yolk.

### Reference Example 1

### Preparation of Enzymatically Treated Egg Yolk

850 g of egg yolk liquid with a salt concentration of 10% (egg yolk content, 765 g), 135 g of water, and 15 g of common salt were mixed with one another and sufficiently preheated at a reaction temperature of 50° C. Then, phospholipase A2 having an enzyme activity of 10,000 IU/mL was added at a concentration of 0.02 wt % based on the egg yolk liquid with a salt concentration of 10%, and the mixture was reacted at 50° C. for 20 hours to give enzymatically treated egg yolk. The lyso ratio was 90%. The lyso ratio was determined by the following method: First, the reaction product was extracted repeatedly with a mixed solvent of chloroform/methanol (3:1) to obtain whole lipids in the reaction product. The resulting lipid mixture was subjected to thin layer chromatography. The lipid mixture was fractionated with two-dimensional thin layer chromatography (one dimension=chloroform:methanol:water (65:25:49) and another dimension=butanol:acetic acid:water (60:20:20)). Fractionated phospholipids were respectively collected and amounts of fractionated lipids of the fractions, respectively, were measured with a commercial measurement kit (permanganate ashing method, Phospholipid Test Wako, manufactured by Wako Pure Chemical Industries, Ltd.). The lyso ratio (%) was determined according to (weight of phosphorus in the lysophospholipid fractions/weight of phosphorus in whole phospholipids)×100.

### Reference Example 2

### Preparation of Untreated Egg Yolk

850 g of egg yolk liquid with a salt concentration of 10% (egg yolk content, 765 g), 135 g of water, and 15 g of common salt were mixed with one another and used as an enzymatically treated egg yolk as comparative subject.

### Test Example 13

### (1) Preparation of Cake Dough

Cake dough was prepared using the formulation shown in Table 4. Foaming fat and oil (foaming fat and oil for cake, “Malish Gold”, Kao Corporation), diacylglycerol-rich fat and oil, enzymatically treated egg yolk, white superior soft sugar, and water were weighed and introduced into a 5-coat mixer. For adjusting the dough temperature, eggs were taken out from a refrigerator (5° C.) and immediately used. The mixture was stirred at low speed for 30 seconds and then at medium speed for 2 minutes. Weak flour (“Biolet”, Nisshin Seifun Group Inc.) and baking powder (“Aikoku Baking Powder, Special Blue Can”, manufactured by Ohmiya Shokuryo Kogyo) were added thereto and stirred at low speed for 30 seconds and stirred at medium speed until the specific gravity of the dough reached 0.6, whereby cake dough was prepared.

### (2) Baking of Cake

180 g of the cake dough obtained above was poured into a frame and baked for 35 minutes in an oven at 180° C.

### Test Example 14

Cake dough was prepared and baked in the same manner as in Test Example 13 except that usual fat and oil (The Nisshin Oilio Group, Ltd.) based on triacylglycerols were used in place of the diacylglycerol-rich fat and oil in Test Example 13, and egg yolk not enzymatically treated was used in place of the enzymatically treated egg yolk.

### Test Example 15

Cake dough was prepared and baked in the same manner as in Test Example 13 except that usual fat and oil (The Nisshin Oillio Group, Ltd.) based on triacylglycerols were used in place of the diacylglycerol-rich fat and oil in Test Example 13.

### Test Example 16

Cake dough was prepared and baked in the same manner as in Test Example 13 except that egg yolk not enzymatically treated was used in place of the enzymatically treated egg yolk in Test Example 13.

### [Evaluation of Workability]

Workability in preparation of cake dough was evaluated by measuring the time required until the specific gravity of dough reached 0.6 at medium speed in the final stage of dough preparation. Because a shorter stirring time is indicative of higher efficiency with less time in operation, it was judged that as the stirring time is decreased, workability is more excellent. The results are shown in Table 4.

### [Evaluation of Cake]

After cake baking, the cake was stored at 25° C. for 3 days and then sensorily evaluated by 2 specialists for its texture in the mouth, that is, (1) soft feeling and (2) dissolving feel, under the following criteria. The cake previously measured for its weight was measured for its volume and height, with a laser volume measuring instrument VM-150 (ASTEX Ltd.), and the specific volume of the cake was determined by dividing the obtained volume by the weight. The results are shown in Table 4.

### [Criteria for Sensory Evaluation]

### (1) Soft Feeling

4: Feels very soft, and very favorable.
3: Feels soft, and favorable.
2: Feels slightly soft.
1: Does not feel soft, and unfavorable.

### (2) Dissolving Feel

4: Very excellent in dissolving feel and not sticky at all.
3: Excellent in dissolving feel and not sticky.
2: Slightly excellent in dissolving feel.
1: Poor in dissolving feel and sticky.

TABLE 4

| (Compounded amount: | | | Test | Test | Test | Test |
|---|---|---|---|---|---|---|
| parts by weight) | | | example 13 | example 14 | example 15 | example 16 |
| Egg yolk liquid not | | | 0 | 150(115) | 0 | 150(115) |
| enzymatically | | | | | | |
| treated (egg yolk | | | | | | |
| content) | | | | | | |
| enzymatically | | | 150(115) | 0 | 150(115) | 0 |
| treated egg yolk | | | | | | |
| liquid (egg yolk | | | | | | |
| content) | | | | | | |
| Water | | | 20 | 20 | 20 | 20 |
| White superior soft | | | 120 | 120 | 120 | 120 |
| sugar | | | | | | |
| Foaming fats and | | | 15 | 15 | 15 | 15 |
| oils | | | | | | |
| Triacylglycerol-rich | | | 0 | 50 | 50 | 0 |
| fats and oils | | | | | | |
| Diacylglycerol-rich | | | 50 | 0 | 0 | 50 |
| fats and oils*¹ | | | | | | |
| Wheat flour | | | 100 | 100 | 100 | 100 |
| Baking powder | | | 1 | 1 | 1 | 1 |
| Total | | | 466 | 466 | 466 | 466 |
| Evaluation | Texture in the | Soft | 4 | 2 | 3 | 3 |
| | mouth | feeling | | | | |
| | | Dissolving | 3 | 1 | 3 | 2 |
| | | feel | | | | |
| | Appearance | Specific | 3.2 | 3.1 | 3.1 | 3.6 |
| | | volume(g/ml) | | | | |
| | | Height(mm) | 54.1 | 52.7 | 52.4 | 58.3 |
| | Workability | Stirring | 2′40 | 2′15 | 1′55 | 3′40 |
| | | time at | | | | |
| | | medium | | | | |
| | | speed in | | | | |
| | | final | | | | |
| | | preparation | | | | |
| | | of dough | | | | |

*¹Glyceride composition: triacylglycerol 14.3 wt %, diacylglycerol 85.2 wt %, monoacylglycerol 0.4 wt %, free fatty acid 0.1 wt %
Fatty acid composition: C16:0 3.0 wt %, C18:0 1.2 wt %, C18:1 38.3 wt %, C18:2 48.6 wt %, C18:3 7.9 wt %, C20:1 0.6 wt %, others 0.4 wt %.

From the results in Table 4, texture in the mouth such as cake soft feeling, dissolving feel, etc. was improved by using enzymatically treated egg yolk, but the cake volume was not particularly sufficient (Test Example 15). By using diacylglycerols, texture in the mouth such as cake soft feeling, dissolving feel, etc. and the cake volume were improved, but the workability was lowered (Test Examples 14 and 16). On the other hand, it was found that by using diacylglycerols in combination with enzymatically treated egg yolk, texture in the mouth such as cake soft feeling, dissolving feel, etc. was improved and simultaneously the cake volume was also improved, thus favorably influencing soft feeling and dissolving feel and improving the appearance as well as workability.

1. A fat and oil composition for bakery products, comprising 20 to 60% by weight of the following components (A) and 3 to 20% by weight, on the dry-weight basis, of the following component (B):
(A) fats and oils containing 10 to 90% by weight of diacylglycerol;
(B) egg yolk.

2. The fat and oil composition for bakery products according to claim 1, wherein the SFC of the fats and oils (A) at 25° C. is 1 to 15.

3. The fat and oil composition for bakery products according to claim 1 or 2, further comprising 15 to 40% by weight of (C) sugars.

4. The fat and oil composition for bakery products according to any of claims 1 to 3, wherein the component (B) has been enzymatically treated.

5. A bakery product comprising 85 to 250 parts by weight of the following component (A) and 14 to 70 parts by weight, on the dry-weight basis, of (B), relative to 100 parts by weight of flour:
(A) fats and oils containing 10 to 90′ by weight of diacylglycerol
(B) egg yolk.

6. The bakery product according to claim 5, wherein the SFC of the fats and oils (A) at 25° C. is 1 to 15.

7. The bakery product according to claim 5 or 6, further comprising 90 to 150 parts by weight of (C) sugars relative to 100 parts by weight of flour.

8. The bakery product according to any of claims 5 to 7, wherein the component (B) has been enzymatically treated.

9. The bakery product according to any of claims 5 to 8, which is produced by preparing the fat and oil composition for bakery products (D) of any of claims 1 to 4 in advance and incorporating 200 to 500 parts by weight of the component (D) into 100 parts by weight of flour.

10. The bakery product according to claim 9, which is produced by mixing 100 parts by weight of flour with a whipped product of 200 to 500 parts by weight of the component (D) to prepare a dough having a specific gravity of 0.5 to 0.8 g/ml and then baking or steaming the dough.

11. The bakery product according to any of claims 5 to 10, wherein the specific volume of the bakery products after production is at least 3 ml/g.

12. A method of producing a bakery product, which comprises preparing the fat and oil composition for bakery products (D) of any of claims 1 to 4 in advance and incorporating 200 to 500 parts by weight of the component (D) into 100 parts by weight of flour.
